(19) United States
(12) Patent Application Publication
(10) Pub. No.: US 2004/0195285 A1
(43) Pub. Date: Oct. 7, 2004

(54) Vehicle tool caddy system

(76) Inventor: Gary A. Pinard, Weare, NH (US)

Correspondence Address: Bourque & Associates, P.A., Suite 301, 835 Hanover Street, Manchester, NH, 03104, US

(21) Appl. No.: 10/407,986

(22) Filed: Apr. 4, 2003

(51) Int. Cl. B60R 11/00; E04G 3/00; B60R 9/00

(52) U.S. Cl. 224/510

(57) ABSTRACT

A tool caddy system for a carrying a tool with a motor and a rotatable workpiece is provided. The system includes an elongated guide member, a vehicle mounting assembly coupled to the guide member and shaped and adapted to be coupled to a vehicle, and a carriage assembly moveably mounted on the guide member and movable along the length of the member.

### TECHNICAL FIELD

The invention relates generally to support frames, and more particularly to support frames to be connected to a motor vehicle for carrying tools.

### BACKGROUND OF THE INVENTION

In the past, when it was necessary to dig a hole in the ice for ice fishing or in the ground for a post hole, a person would need to manually drag the auger (or hole digger) to the desired hole location. Depending on the weight of the auger and on the site of the location(s), and the number of holes to be dug, this could be a long and tiresome project. Additionally, once the auger was brought to the desired hole location, the user would have to support the heavy auger by himself when attempting to drill a hole. This could be very difficult in the case of post holes, which need to generally be straight.

Thus, there is a need for an auger caddy which can be connected to a motor vehicle to transport the auger from place to place and which can support and align the auger to allow a user to easily and properly drill holes.

### SUMMARY OF THE INVENTION

The present invention solves this and other problems by providing an auger caddy which can be connected to a motor vehicle and which can support and align the auger to allow a user to easily transport the auger, as well as drill and properly align holes.

In one form, the invention includes a tool caddy system for a carrying tool with a motor and a rotatable workpiece. The system includes an elongated guide member, a vehicle mounting assembly coupled to the guide member and shaped and adapted to be coupled to a vehicle, and a carriage assembly for supporting the tool and moveably mounted on the guide member and movable along the length of the member.

### BRIEF DESCRIPTION OF THE DRAWINGS

These and other features and advantages of the present invention will be better understood by reading the following detailed description, taken together with the drawings wherein:

FIG. 1 is a schematic side elevational view of the tool caddy system of the present invention with an auger attached thereto;

FIG. 2 is a partial perspective view of the tool caddy system attached to a receiver mounted on a motor vehicle;

FIG. 3 is a front plan view of the tool caddy system;

FIG. 4 is a partial side elevational view of one embodiment of a guide roller assembly attached to a side plate of the carriage assembly of the tool caddy system;

FIG. 5 is a schematic representation of a carriage assembly with one of its side plates removed in a locked position with the guide tube, a portion of which has been broken away;

FIGS. 6A and 6B are respectively opposite side elevational views of a guide tube with a portion of the guide tube broken away;

FIG. 7 is a schematic side elevation view of an alternative vehicle mount for a tool caddy system in accordance with the present invention;

FIG. 8 is a top plan view of the tilting adjusting mechanism of the vehicle mount embodiment of FIG. 7;

FIG. 9 is an exploded partial top plan view of the rotational adjustment mechanism of the embodiment of FIG. 7;

FIG. 10 is a front plan view of the cap of FIG. 9;

FIGS. 11A and 11B are respectively top and side plan views of a tow bar accessory for the present invention;

FIG. 12 is a partial side schematic view of the rear portion of a snowmobile illustrating its lift bar;

FIG. 13 is a top plan view of the snowmobile hitch converter attached to the lift bar of FIG. 12;

FIG. 14 is an exploded top plan view of an optional securing device of the present invention; and

FIG. 15 is a partial sectional schematic view illustrating the securing device attached to the guide tube and the rack bar of the vehicle of FIG. 2.

### DETAILED DESCRIPTION OF THE PREFERRED EMBODIMENT

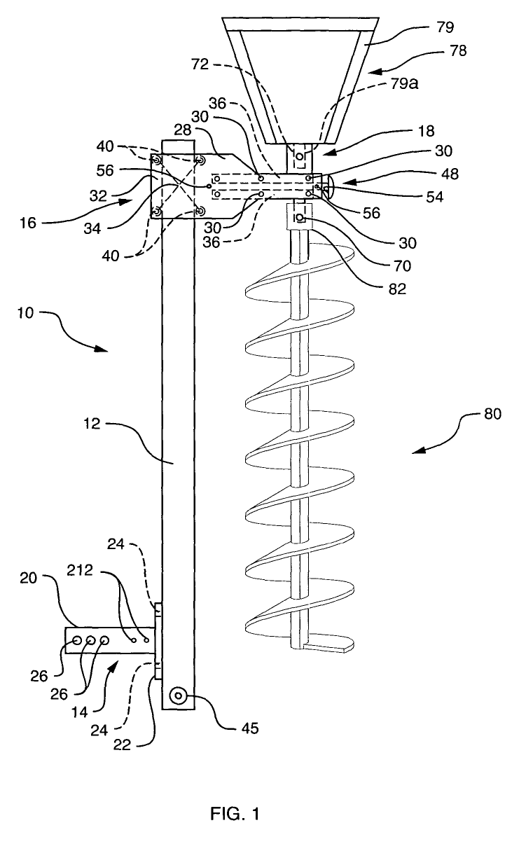

Referring to FIG. 1, a portable tool caddy system 10 is shown. The tool caddy system 10 includes an elongated vertically-oriented guide member, such as a hollow box-shaped guide tube 12, a vehicle mounting assembly 14, a moveable and lockable carriage assembly 16 and a tool coupling 18.

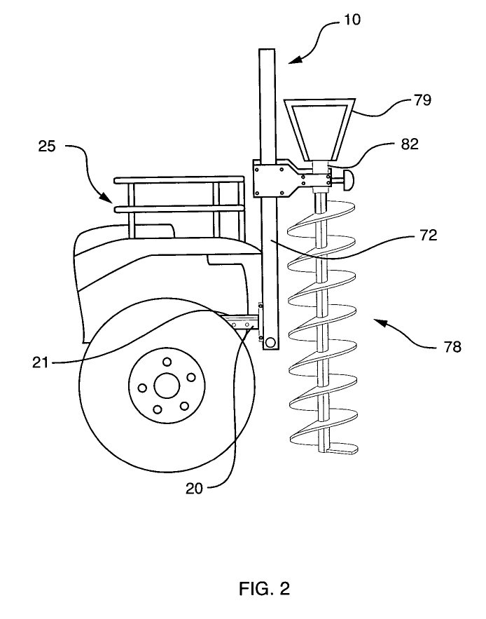

An exemplary vehicle mounting assembly 14 is used to connect the tool caddy system 10 to a motor vehicle. The vehicle mounting assembly 14, shown in FIG. 1, is shown in the form of a trailer type hitch (although this is not a limitation of the present invention) and includes a box-like hollow tube 20, generally square in cross-section, coupled to an attachment plate 22 having two holes 24 which allow the vehicle mounting assembly 14 to be bolted to a lower end of the guide tube 12 in a conventional manner (see FIG. 1). The tube 20 is received within a complementary hitch receiver 21 of a motor vehicle 25 in a conventional manner (see FIG. 2). The tube 20 is removeably attached to the receiver by passing a bolt through a hole in the receiver and one hole from among one or more holes 26 disposed in tube 20.

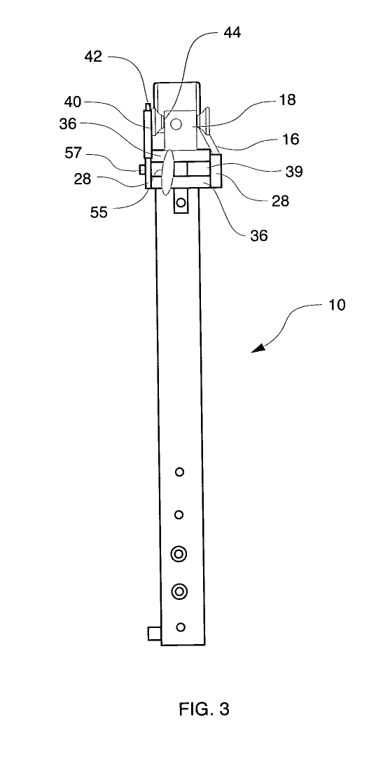

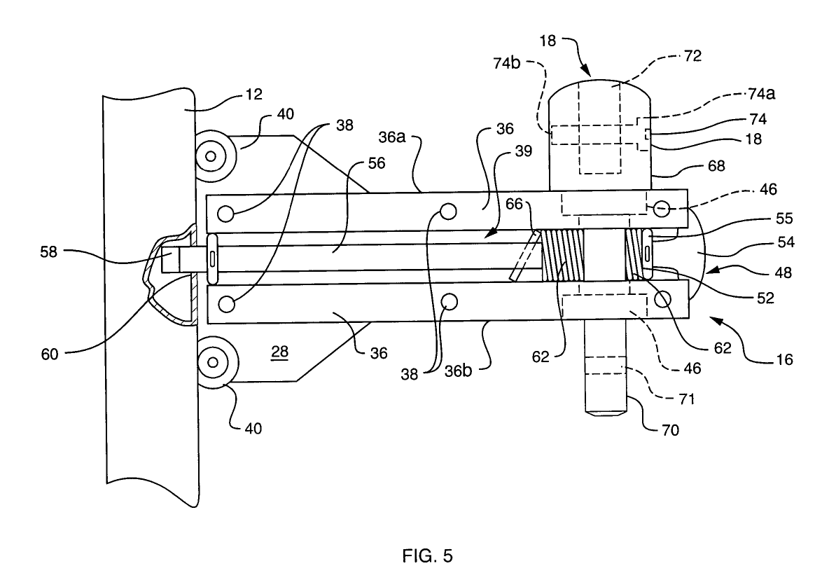

The carriage assembly 16 is moveably mounted on the guide tube 12 so that it can travel vertically along the majority of the length of the guide tube 12. The carriage assembly 16 includes two parallel side plates 28 (best seen in FIGS. 1 and 3). In the preferred embodiment, as seen in FIG. 1, each side plate 28 has a number of side plate holes 30 and a wider end 32 with four roller assembly holes 34. The side plates 28 are attached to two generally parallel and spaced apart housing plates 36 (see FIGS. 1 and 3), by bolts (not shown) disposed through the holes 30 of the side plate 28 and into associated holes 38 on sides of the housing plate 36 (see FIG. 5). As seen in FIG. 5, plates 36 and 28 form a gap 39 therebetween.

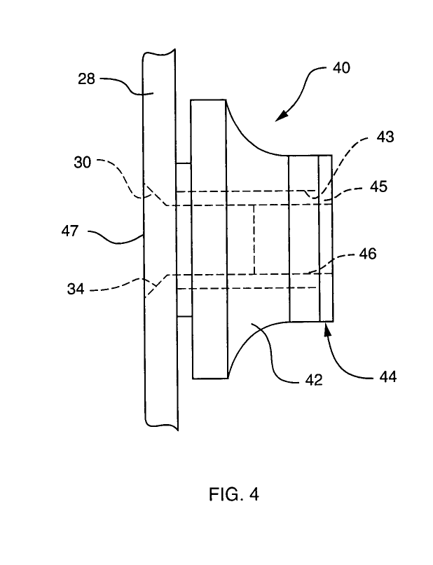

Each side plate 28 of the carriage assembly 16 also is attached to four roller assemblies 40, FIG. 1. The roller assemblies 40, as seen in greater detail in FIG. 4, are each formed of a guide roller 42 having a non-threaded hole 43, and a bushing 44 disposed within the hole 43 of guide roller 42 and having a flange 45. The bushing 44 includes a threaded hole 46. Bolts 47 (only shown in FIG. 4) respectively pass through associated roller holes 34 of side plates 28 and is threaded to the bushing 44 to attach the roller assemblies 40 to the side plates 28 while allowing the guide rollers 42 to rotate freely.

As best seen in FIG. 1, (and seen partially in FIGS. 3 and 4) the roller assemblies 40 are disposed adjacent four corners of the guide tube 12 to allow the carriage assembly 16 to easily be moved (i.e. rolled) up and down the length of the guide tube 12. A stop 45 (FIG. 1) may be attached to and project from the bottom of guide tube 12 to prevent the carriage assembly 16 from traveling below the lower end of the guide tube 12.

As seen best in FIG. 5, housing plates 36 each also include a spindle hole 46 with conventional surrounding and rotatably supporting the tool coupling 18 discussed below.

As seen in FIG. 5, carriage assembly 16 also typically includes a locking pin handle 48 disposed through the gap 39 (FIGS. 3 and 5) formed by plates 28, 36. The locking pin handle 48 which includes a locking pin 50 having a threaded end 52 connected to a T-handle 54. The locking pin handle 48 may be attached to one of the side plates 28 via two spaced apart eye bolts 55 (FIG. 5) each having a threaded end passing through respective holes 56 (FIG. 1) of one of the side plates 28 and coupled thereto with a nut 57 (FIG. 3) in a conventional manner.

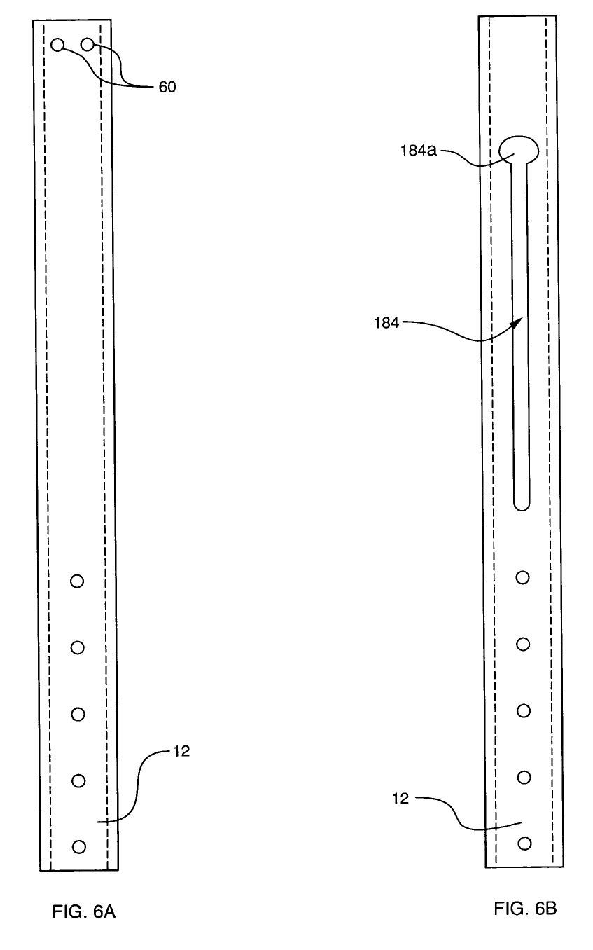

When, as seen in FIG. 5, a longitudinal end 58 of the locking pin 50 disposed away from the t-handle 54 is disposed through one of two locking holes 60 in the guide tube 12 (see also FIG. 6A), the carriage assembly 16 is locked in place and is not moveable along the length of the guide tube 12. The locking pin handle 48 is maintained in a locked position by a compression spring 62 disposed between one of the eye bolts 55 and a roll or spring pin 66 in the locking pin 50.

The carriage assembly 16 is coupled to or supports a tool such as an auger 78. This may require the use of a tool coupling 18 in the form of a spindle. The tool coupling allows a tool motor and tool bit to be mounted to the top and bottom regions of the spindle respectively. Those skilled in the art recognize that other motor mounting possibilities exist which may not require the need for a tool coupling.

The tool coupling 18, as seen in FIG. 5, has a larger diameter hollow motor coupling end 68 and a solid smaller diameter workpiece coupling end 70 having a hole 71 therethrough. As seen in FIG. 1 (see also FIG. 3), the tool coupling 18 is shown coupled to an auger 78 having a motor 79 (shown schematically in FIG. 1), a motor shaft 79A, and a drill bit 80 (shown schematically in FIG. 1). Other tools may also be coupled to the coupling 18 or carriage assembly 16. Referring to FIG. 5, the workpiece coupling end 70 is coupled to the drill bit 80 of the auger 78 by placing a cap 82 of the drill bit 80 having diametrically aligned holes over the workpiece coupling end 70, aligning the holes of the cap 82 with hole 71 and passing a bolt through the aligned holes in a conventional manner.

The motor coupling end 68 includes a generally cylindrical axial cavity 72 and an interrupted hole 74 having portions 74A, 74B. The hole 74 having an axis generally perpendicular to the axis of cavity 72. The motor coupling 68 is, as seen in FIG. 1, attached to the motor shaft 79a of the auger 78 by inserting the shaft 79a into cavity 72 (shaft 79a has a hole passing diametrically therethrough (not shown)). The hole of shaft 79a is aligned with holes 74A, 74B (see FIG. 5) and a bolt (not shown) is passed through the hole of shaft 79a and aligned hole portions 74A, 74B to couple the shaft 79a to the motor coupling 68.

The tool coupling 18 advantageously has a length greater than the distance between a top 36a of one plate 36 and a bottom 36b of the other plate 36 (see FIG. 5). This allows the carriage assembly 16 to support the weight of the auger 78 (or other tool) while allowing the tool coupling 18 to provide a rotatable connection between the motor 78 and bit 80, to allow the motor 79 to rotate the bit 80.

The tool caddy system 10 can be used as follows. The vehicle mounting assembly 14 is attached to a motor vehicle, as discussed above, such as with a complementary receiver. An ice auger 78, or other tool, is coupled to the tool coupling 18 as discussed above. The carriage assembly 16 is removed from the locking position by pulling the t-handle 54 of the locking pin handle 48 away from the guide tube 12 to pull the end 58 of locking pin 50 out of the hole 60 of the guide tube 12 it was disposed and held in place with compression spring 62. Gravity urges the carriage assembly 16 and the attached auger 78 to move vertically down along the axis of the guide tube 12 so that the drill bit 80 can contact the ice, or other surface, to drill a hole.

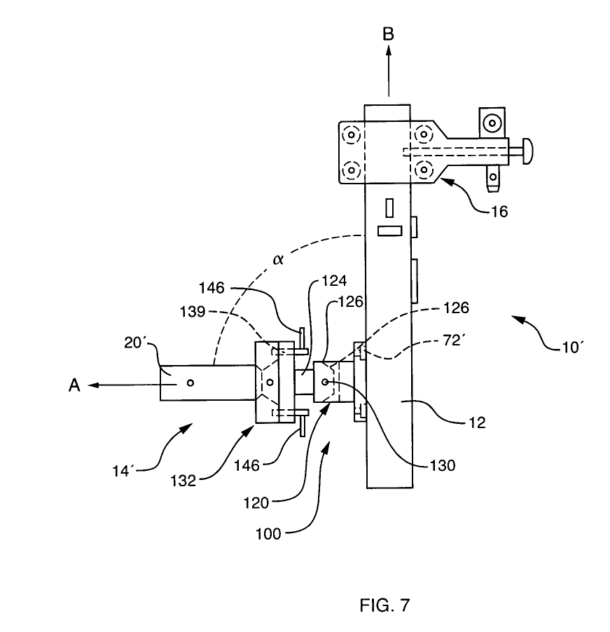

An alternative tool caddy system 10′ is shown in FIG. 7 and includes an adjusting device 100 to allow the vertical axis of the drill bit to be adjusted so that axes of adjacent holes drilled by the tool carried by system 10′ can be generally parallel to one another. This is especially useful when the tool carried by system 10′ is used to dig post holes for fence posts and the terrain to be drilled is not level. This allows the finished fence to be erected in a substantially straight position, whereby the axes of the erected fence posts are generally parallel with one another.

The tool caddy system 10′ is identical to the tool caddy system 10 of FIGS. 1-12 except that the vehicle mounting assembly 14′ includes the adjusting device 100 which disposed between the tube 20′ and plate 22′. The tube 20′ and guide tube 12 include respective axes A and B (FIG. 7).

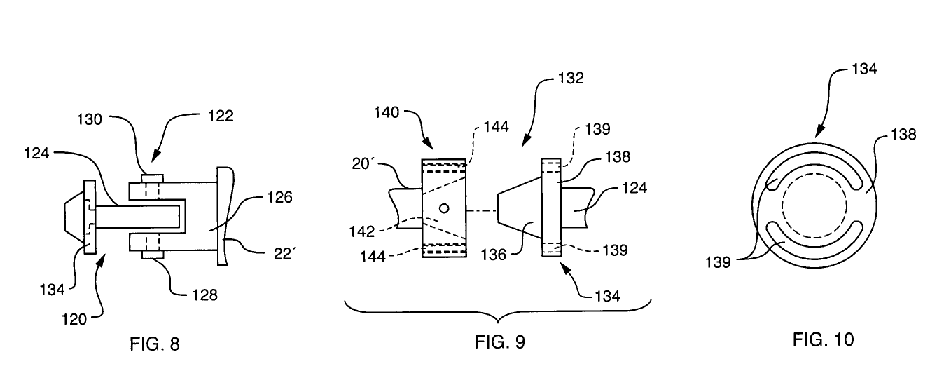

The adjusting device 100 includes a tilting adjusting mechanism 120, as best seen in FIG. 8, in the form of a clevis mount 122. The tilting adjustment mechanism 120, as seen in FIG. 8, includes a bar 124 coupled to the plate 22′ and rotatably coupled to a slotted bar 126 coupled to tube 20′. The bar 124 is rotatably coupled to the slotted bar 126 by a nut 128 and bolt 130, or other similar device. As seen in FIG. 7, longitudinal axis B of the guide tube 12 and the axis A parellel to tube 20′ form an angle α. The slotted bar 126 is rotatable about the axis of the bolt 130, whereby the axis of the guide tube 12 and drill bit 78 can be adjusted with respect to the axis A of tube 20′ to increase or decrease the angle α (FIG. 7).

The adjusting device 120 also includes a rotational adjustment mechanism 132 attached to the bar 124. As seen in FIG. 9, the rotational adjustment mechanism 132 includes a cap 134 coupled to bar 124 having a frusto-conical shaped insert 136. The rotational adjustment mechanism 132 also includes a cylindrical receiver 140 attached to guide tube 20′ having a frusto-conical bore 142 for receiving the insert 136 and two threaded bores 144 disposed radially outward of the frusto-conical bore 142, (grease is usually disposed between the frusto-conical shaped insert 136 and the frusto-conical bore 142). The rotational adjustment mechanism 132 also includes two threaded locking levers 146 (FIG. 7) each of which passes through an associated semi-circular slot 139 (see FIG. 10) in cap 134 and a bore 144 in receiver 140 to lock the cap 134 to the receiver 140.

To rotate the axis B of the guide tube 12 and the drill bit 80 relative to the upright vertical direction, the locking levers 146 are loosened and the cap 134 can be rotated relative to the receiver 140.

The guide tube 12 may also be fitted with vertical and horizontal levels (not shown) to assure the axis of the drill bit 80 and holes to be dug are properly aligned.

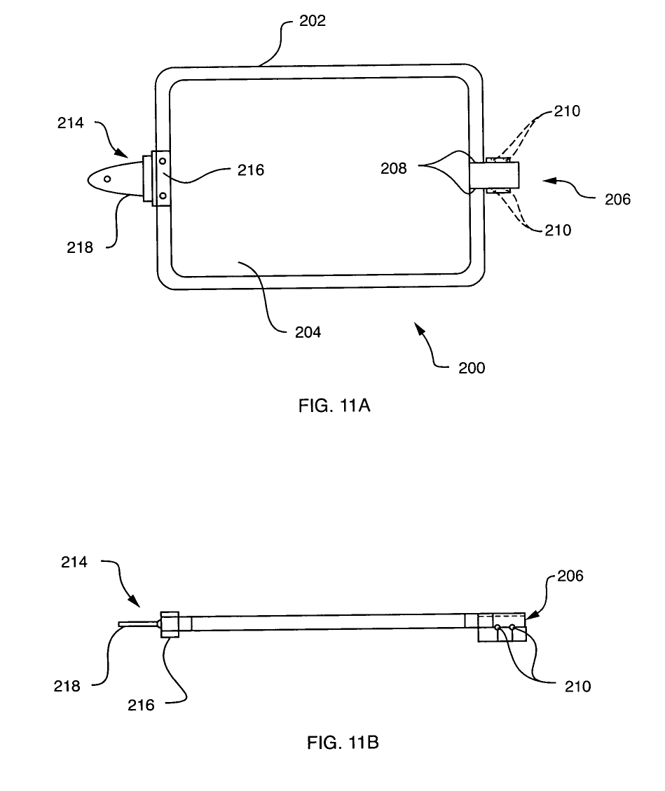

As seen in FIGS. 11A-11B, the tool caddy of FIG. 1 may be coupled to a tow bar 200 formed of tubing 202 shaped into an open rectangle to define a bore 204 through which the drill bit 78 may pass. The tow bar 200 also includes an open channel connecting member 206 having spaced apart plates 208 each having two bores 210. The connecting member 206 fits around tube 20 and is connected by bolts passing through bores 210 and guard mounting holes 212 (FIG. 1) in the tube 20 in a conventional manner.

The tow bar 200 may also include a towing connector 214 disposed on tubing 202 at a position diametrically opposed to connecting member 206 for connection to a sled or other vehicle to also be towed by the motor vehicle. The towing connector 214 may include a U-shaped connecting bracket 216 bolted to tubing 202 and connected to a hinged flap 218 for connection to the object to be towed.

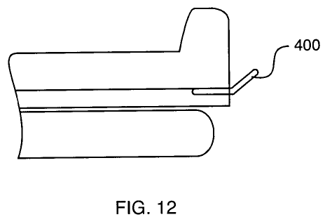

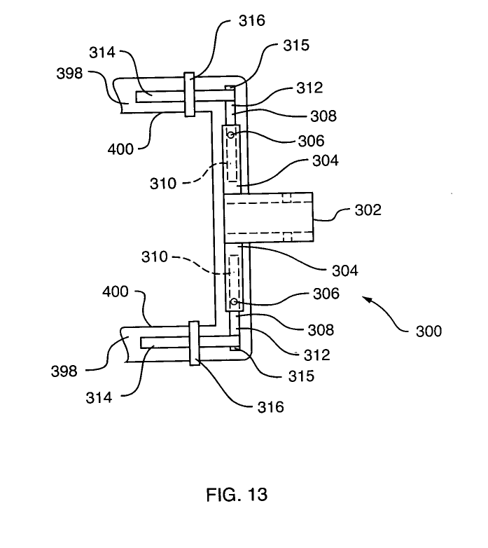

The usefulness of the present invention may be increased with the use of a hitch converter 300 for a snowmobile, or the like, to receive the tube 20 of the tool caddy system 10 of FIG. 1. The hitch converter 300, shown in FIG. 13, includes a box like hitch receiver 302 (similar to receiver 21) coupled to two coaxial pipes 304 each having a bore 306. Two telescoping arms 308 have ends 310 respectively disposed in and moveable within the pipes 304 and opposite ends 312 having an internally threaded bore and respectively connected to a swing arm 314 by a bolt 315. The hitch converter 300 sits on top of and is attached to a snowmobile lift bar 400 (see FIG. 12) as follows. After the arms 308 are moved in or out of pipes 304 to adjust the length therebetween, they are locked by set screws (not shown) which pass through the bores 306. The arms 314 are then respectively connected by one or more u-bolts 316 to side tubing 398 of the snowmobile lift bar 400 (see FIG. 13) so that the hitch receiver 302 extends beyond the rear of the snowmobile lift bar 400 to receive the tube 20 of the tool caddy system 10 as described above.

Referring back to FIG. 2, in come cases, the receiver 21 and vehicle mounting assembly 14 may not provide an adequate coupling, whereby the upper end of the guide tube 12 coupled to the carriage assembly 16 tends to sway front to back, and to move away from the rear of the motor vehicle 25. The present invention optionally provides a securing device 170 to prevent this movement.

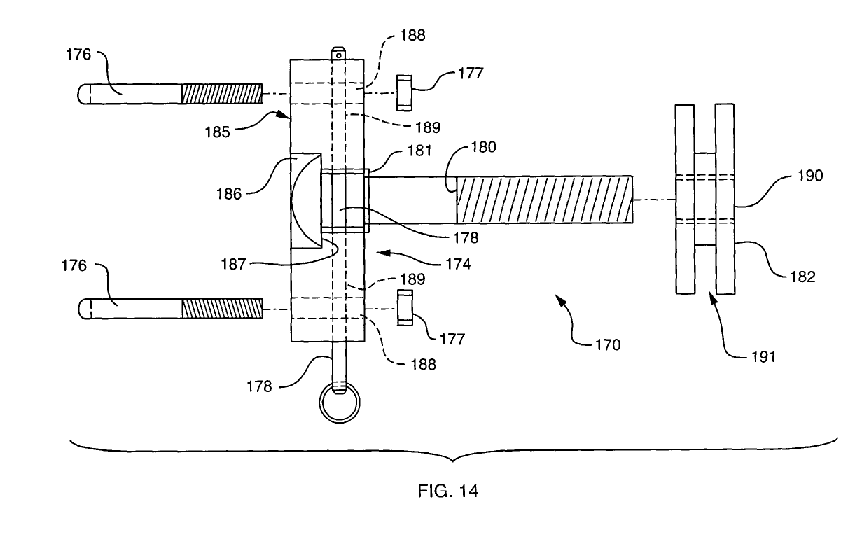

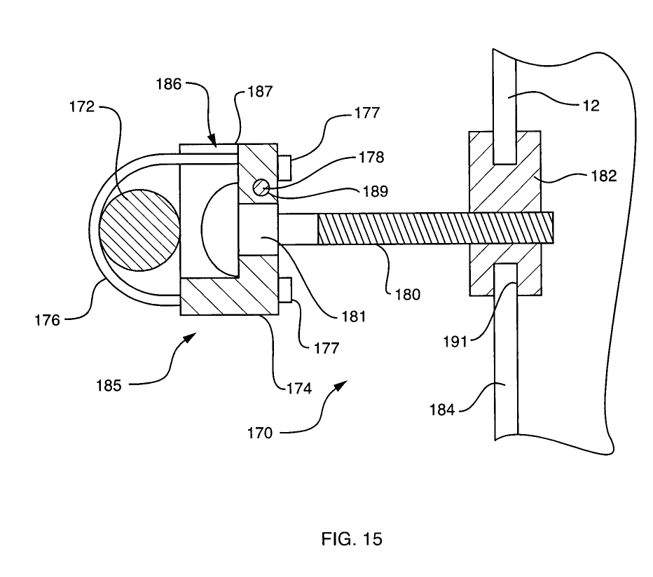

As seen in FIGS. 14 and 15, the securing device 170 is attached to a rack bar or other similar vehicle mounted support 172 (see also FIG. 2) of the vehicle 25 and the guide tube 12.

As seen in FIG. 14, one embodiment of the securing device 170 includes a bracket block 174, two U-bolts 176, four cap nuts 177, a locking pin 178, a carriage bolt 180, a threaded slotted disk 182, and a slot 184 formed in guide tube 12 having a circular end 184a (see FIG. 6B).

As seen in FIGS. 14 and 15, the bracket block 174 includes a body 185 forming an open U-shaped passageway 186 surrounded by a U-shaped shoulder 187, four holes 188 (only two visible) and an interrupted hole 189 separated by the U-shaped passageway 186. The slotted disk 182 includes a threaded hole 190 and a central circumferential slot 191.

In use, the bracket block 174 is attached, as seen in FIG. 15, to the rack bar 172 of vehicle 25 by passing each of the U-bolts 176 around the rack bar 172 and through two associated holes 188 and securing each of the U-bolts 176 with two associated nuts 177. The slotted disk 182 is threaded onto bolt 180 and inserted into the circular end 184a of the slot 184 of the guide tube 12. The disk 182 is moved downwards so that the walls of the disk 182 defining the circumferential slot 191 trap therebetween the wall of the guide tube 12 defining slot 184 to moveably attach the disk 182 to guide tube 12.

The entrapped disk 182 and bolt 180 are then moved along the slot 184 to the level of the bracket block 174 and attached rack bar 172. If necessary, the bolt 180 is threadably adjusted. The square neck 181 of bolt 180 is placed in the U-shaped passageway 186 of the bracket bolt 174. The locking pin 178, of conventional form, is passed through the interrupted hole 189 to releasably lock the bolt 180 within the passageway 186. The securing device 170 thus aids in preventing the guide tube 12 from moving away from the vehicle 25.

Modifications and substitutions by one of ordinary skill in the art are considered to be within the scope of the present invention which is not to be limited.

What is claimed is:

1. A tool caddy system for carrying a tool with a motor and a rotatable workpiece, the system comprising:
an elongated vertical guide member having a length;
a vehicle mounting assembly, coupled to the guide member and shaped and adapted to be coupled to a vehicle; and
a carriage assembly for supporting the tool and moveably mounted on the guide member to be moveable along the length of the guide member.

2. The system of claim 1, and further including a locking mechanism, coupled to the carriage assembly, to lock the assembly along the length of the member.

3. The system of claim 2, wherein the locking mechanism includes a locking pin moveably coupled to the carriage assembly and at least one hole formed in the guide member to removeably receive the locking pin.

4. The system of claim 1, wherein the tool coupling includes a motor coupling for coupling to the motor and a workpiece coupling for coupling to the rotatable workpiece.

5. The system of claim 4, wherein the tool coupling is in the form of a spindle.

6. The system of claim 1, wherein the guide member includes an axis and the tool coupling includes means for aligning an axis of the workpiece substantially parallel to the axis of the guide member, and further comprising rotational adjustment means, coupled to the guide member, for rotating the axis of the guide member about the axis of the vehicle mounting assembly.

7. The system of claim 6, wherein the rotational adjustment means includes a receiver defining a bore coupled to one of the guide member or the vehicle mounting assembly and an insert coupled to the other of the guide tube or vehicle mounting assembly, wherein the bore is shaped and adapted to receive the insert.

8. The system of claim 7, wherein the bore and insert each have a generally frustoconical shape.

9. The system of claim 6, wherein the axis of the guide member and the axis of the vehicle mounting assembly form an angle, and further comprising a tilting adjusting mechanism, coupled to the guide member and vehicle mounting assembly, for adjusting the angle.

10. The system of claim 9, wherein the second tilting adjustment mechanism includes a clevis mount.

11. The system of claim 1, and further comprising a securing device to further secure the system to the vehicle.

12. The system of claim 11, wherein the securing device includes a bracket coupled to the vehicle, a slotted disc coupled to a slot in the guide member, and a pin member coupled between the bracket and the slotted disc.

13. The system of claim 1 wherein the carriage assembly includes a rotatable tool coupling, for coupling the tool motor to the rotatable workpiece while supporting the tool.

14. A tool caddy system for carrying a tool with a motor and a rotatable workpiece, the system comprising:
an elongated vertical guide member having a length;
a vehicle mounting assembly, coupled to the guide member and shaped and adapted to be coupled to a vehicle; and
a carriage assembly for supporting the tool and moveably mounted on the guide member to be moveable along the length of the guide member, wherein the carriage assembly includes a rotatable tool coupling, for coupling the tool motor to the rotatable workpiece while supporting the tool.
